(19) United States
(12) Patent Application Publication
(10) Pub. No.: US 2011/0302781 A1
(43) Pub. Date: Dec. 15, 2011

(54) METHOD FOR PROVIDING RUB COATINGS FOR GAS TURBINE ENGINE COMPRESSORS

(75) Inventors: Albert S. DODD, IV, Cincinnati, OH (US); Thomas John Tomlinson, West Chester, OH (US); William R. Rossey, JR., Mason, OH (US)

(73) Assignee: GENERAL ELECTRIC COMPANY, Schenectady, NY (US)

(21) Appl. No.: 13/214,842

(22) Filed: Aug. 22, 2011

Related U.S. Application Data
(62) Division of application No. 11/553,111, filed on Oct. 26, 2006.
(60) Provisional application No. 60/745,534, filed on Apr. 25, 2006.

(51) Int. Cl. B23P 6/00

(52) U.S. Cl. 29/889.1

(57) ABSTRACT

Rub coatings, and methods for applying rub coatings, are provided for compressor assemblies of gas turbine engine assemblies. The coating may be applied as an initial coating to a new surface of a component, as well as a repair and replacement corrosion resistant rub coating for applying to a previously coated component of a gas turbine engine assembly such as a compressor casing. The method includes the steps of providing a component of a gas turbine engine assembly, the component having predetermined dimensions and specifications for operational use in an engine assembly. The component has a surface having a damaged rub coating thereon, the damaged rub coating not in compliance with the predetermined dimensions and specifications. The method includes removing the non-compliant damaged rub coating to expose the surface. Next, a repair corrosion resistant rub coating comprising MCrAlX is applied to the surface. Finally, the repair corrosion resistant rub coating comprising MCrAlX is machined to restore the coated component to comply with the predetermined dimensions and specifications.

### CROSS REFERENCE TO RELATED APPLICATIONS

This application relates to and claims the benefit of U.S. patent application Ser. No. 11/553,111, filed Oct. 26, 2006, entitled “Rub Coating for Gas Turbine Engine Compressors,” which claims priority to U.S. Provisional Application No. 60/745,534 filed Apr. 25, 2006, entitled “Rub Coating for Gas Turbine Engine,” now abandoned, the disclosures of which are incorporated by reference in its entirety.

### FIELD OF THE INVENTION

This invention relates to abradable rub coatings for components exposed to high temperatures, such as the hostile thermal environment of a gas turbine engine. More particularly, this invention is directed to a composition and method for providing MCrAlX alloys, and particularly NiCrAlY alloys, as a rub coating on compressor flowpath surfaces, and particularly on compressor housings, in a gas turbine engine assembly.

### BACKGROUND OF THE INVENTION

Higher operating temperatures for gas turbine engines are continuously sought in order to increase their efficiency. However, as operating temperatures increase, the high temperature durability of the components of the engine must correspondingly increase. Significant advances in high temperature capabilities have been achieved through the formulation of nickel and cobalt-base superalloys. Nonetheless, when used to form components of the turbine, combustor and augmentor sections of a gas turbine engine, such alloys alone are often susceptible to damage by oxidation and hot corrosion attack and may not retain adequate mechanical properties. For this reason, these components are often protected by an environmental bond coat and/or thermal-insulating coating, the latter of which is termed a thermal barrier coating (TBC) system. However, in the compressor, rub coatings are used to minimize clearances between rotating components and static casing structure to improve engine operating efficiency. Historically, the problem with known rub coatings is that they can spall off due to corrosion/oxidation between the rub coating and the compressor casing. For example, the spalling problem has occurred in compressor assemblies having Inconel 90X series base metal alloy substrates with nickel-aluminum (Ni—Al) rub coatings.

Ni—Al rub coatings applied to turbine engine compressor flowpath components such as compressor casings, are known to crack and otherwise fail when subjected to repeated heat cycling of the engine during normal operation. For purposes of this application, “rub coatings” are defined as coatings that are corrosion-resistant, adherent, and durable at elevated temperatures such as those created by an operating turbine engine, yet can be abraded by contact with another operating engine component (such as rotating HPC blade tips upon first startup of a new or repaired gas turbine engine) without significantly compromising the desired corrosion-resistance, adherent and durable properties of the coating. Abrading the rub coating in this manner creates a minimal clearance between the compressor blade tips and the compressor casing that permits the compressor to operate at maximum efficiency with little or no leakage losses between the blade tip and flowpath, thereby increasing or maintaining maximum flowpath gas pressure. However, this maximum efficiency is lost if the rub coating fails and compromises the desired tolerances between the coating and the HPC blade tips. Large gaps between the HPC blade tips and compressor casing cause the engine to run inefficiently, requiring the engine to run faster and hotter to provide the same level of thrust, burning more fuel and placing greater stress on engine components in the process.

One known Ni—Al alloy rub coating used on compressor flowpath surfaces for gas turbine aircraft engines comprises a prealloyed powder made from atomized nickel aluminum metal (rather than being provided as separate nickel powder and aluminum powder that would need to be mixed at time of application) is applied by a conventional plasma spray method (also known as “flame” application). That Ni—Al rub coating initially provides desirable rub coating characteristics, but after numerous thermal cycles exhibits thermal cycle induced craze-cracking (also known as “mud flat cracking” due to the similar appearance to naturally desiccated mud). Craze cracking and interface attack lead to oxidation and corrosion at the bond-line between the substrate and the coating, and ultimately leads to rub coating failure. In addition to lost efficiency from non-conforming gaps between the damaged rub coating and the HPC blade tips, rub coating failure can cause catastrophic damage as liberated coating particulates enter the turbine engine flowpath. Liberated coating particles cause extensive damage to downstream compressor blades with resulting engine stalls, exhaust gas temperature exceedence, unscheduled engine removal, and inefficient operation on-wing. An engine overhaul is required to replace damaged blades and repair or replace the damaged rub coating, and requires the engine to be pulled from service at great cost and inconvenience to airline customers. Such an overhaul necessitates engine teardown, mechanical chemical or water jet stripant to remove old coating, followed by application of new Ni—Al rub coating material, such as by thermal spray, followed by machining to restore flowpath dimensional characteristics. However, re-applying the Ni—Al rub coating to form a repair coating simply re-starts the pre-described cycle, since after the repaired engine returns to service, the Ni—Al repair rub coating exhibits this same craze-cracking as thermal cycles are accumulated.

Thus, there is a continuing need for corrosion resistant rub coatings that can withstand the extreme environments of a flowpath of a gas turbine engine without failing, yet are easy to apply and easy to repair.

Additionally, in known component coating systems for engine components such as turbine blades and turbine housings, ceramic coatings, and particularly yttria-stabilized zirconia (YSZ), are widely used as a thermal barrier coating (TBC), or topcoat, of TBC systems. To promote adhesion and extend the service life of a TBC system, a bond coat is often employed. Bond coats are typically in the form of overlay coatings such as MCrAlX (where M is iron, cobalt and/or nickel, and X is yttrium or another rare earth element), or alternatively, diffusion aluminide coatings. During the deposition of the ceramic TBC and subsequent exposures to high temperatures, such as during engine operation, these bond coats form a tightly adherent alumina (Al₂O₃) layer or oxide scale that adheres the TBC to the bond coat. It is contemplated by the inventors that the properties of MCrAlX coatings might be beneficial to compressor component assemblies.

Accordingly, it would be desirable to provide a corrosion-resistant, crack-resistant rub coating for use on compressor casings of gas turbine engines, wherein the coating exhibits excellent adhesion and corrosion resistance to the substrate while being abradable enough to accept a groove from penetrating turbine blade tips without compromising adhesion, corrosion resistance, durability and other desirable performance characteristics.

It would further be desirable to provide an improved method of repairing a gas flowpath part having a damaged rub coating thereon, wherein the damaged rub coating is removed and replaced with an improved rub coating, imparting a longer service life to the repaired coated parts while minimizing future rub coating failures.

### SUMMARY OF THE INVENTION

The present invention provides a coating composition that can be applied to form a rub coat on compressor flowpath components of gas turbine engines. The invention further provides methods for applying the coating composition to establish and/or repair a rub coating on a compressor flowpath component of a gas turbine engine, whether the component is new or has previously been coated with a rub coating such as an Ni—Al rub coating. Preferably, the component is a compressor casing having a plurality of stages.

The invention can be used in any gas turbine flowpath component having a rub coating thereon, such as low, intermediate, and high-pressure compressor casings used on aircraft engines or aeroderivative turbines for electrical power generation and marine propulsion. In the case of power generation turbines, the cost of completely halting power generation for an extended period in order to remove, repair and then reinstall a component that has suffered only localized spallation is avoided. Also avoided is the need to decide whether or not to continue operation of the turbine until the spalled component is no longer salvageable at the risk of damaging the component and the turbine.

In one embodiment, the invention comprises a method of providing an improved corrosion and wear resistant coating to a previously coated component of a gas turbine engine assembly. The method includes the steps of providing a component of a gas turbine engine assembly, the component having predetermined dimensions and specifications for operational use in an engine assembly. The component has a surface having a rub coating thereon, the rub coating not in compliance with the predetermined dimensions and specifications. The method includes removing the non-compliant rub coating to expose the surface. Next, a corrosion resistant rub coating comprising MCrAlX is applied to the surface. Finally, the abradable corrosion and wear resistant coating is machined to restore the coated component to comply with the predetermined dimensions and specifications.

In another embodiment, the invention comprises a repaired component of a gas turbine engine assembly, the component having a corrosion resistant rub coating thereon. The corrosion resistant rub coating comprises MCrAlX applied to the component surface. Preferably, the MCrAlX is NiCrAlY.

In yet another embodiment, the invention comprises a compressor casing for a gas turbine engine assembly, the casing comprising a surface coated with a corrosion resistant rub coating. The corrosion resistant rub coating comprises MCrAlX, and more preferably comprises NiCrAlY. NiCrAlY effectively addresses the two key drivers of coating failures: (1) this material is less sensitive to engine thermal cycles and does not craze-crack, and (2) the coating bond line is protected from oxidation/corrosion. With minimized cracking or bond failure, any spalling or other damage to the NiCrAlY coating is reduced or eliminated.

Other objects and advantages of this invention will be better appreciated from the following detailed description. Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIGS. 1 and 2 show schematic representations of a compressor case of a gas turbine engine, indicating compressor stages that are traditionally protected by a rub coating such as nickel aluminum (Ni—Al).

FIG. 3 is a photograph of a compressor casing removed from service by an airline showing spalling and liberation of a Ni—Al rub coating at the coating/base metal bond line.

FIG. 4 is photograph showing cross-sectional view of a compressor casing of FIG. 3, showing spalling and liberation of the prior art Ni—Al rub coating at the coating bond line for stage 8.

FIGS. 5 through 8 show photographs of a compressor casing sector coated with 0.040 inch of the prior art Ni—Al rub coating applied by thermal spray showing the results of 2856 cycles of furnace cycle testing (FCT), including cracking and spalling.

FIGS. 9 through 12 show photographs of a compressor casing section coated with the NiCrAlY rub coating of the present invention applied by thermal spray, showing the results of 2856 cycles of FCT, with no cracking or spalling.

FIGS. 13 and 14 show photomicrographs of coupons prepared using the prior art Ni—Al rub coating and the NiCrAlY rub coating of the present invention, respectively, showing the results of coating wear testing.

FIGS. 15 through 18 are a series of photomicrographs of blade tips showing the results of blade wear testing, comparatively showing prior art Ni—Al versus NiCrAlY rub coating of the present invention, respectively.

Whenever possible, the same reference numbers will be used throughout the drawings to refer to the same or like parts.

### DETAILED DESCRIPTION OF THE INVENTION

The present invention is directed to components in the compressor section of gas turbine engine assemblies that are covered by environmental corrosion-resistant rub coatings for operation within environments characterized by relatively high temperatures, and therefore subjected to severe thermal stresses and thermal cycling. Notable examples are primarily compressor casings of gas turbine engines for use in aircraft and industrial applications. While the advantages of this invention are particularly applicable to components of gas turbine engines, the invention is generally applicable to any component in which a metal alloy substrate requires an abradable, corrosion-resistant and heat resistant coating having excellent adhesion and a coefficient of thermal expansion that makes the coating resistant to spalling, cracking, and other adhesion-related failures.

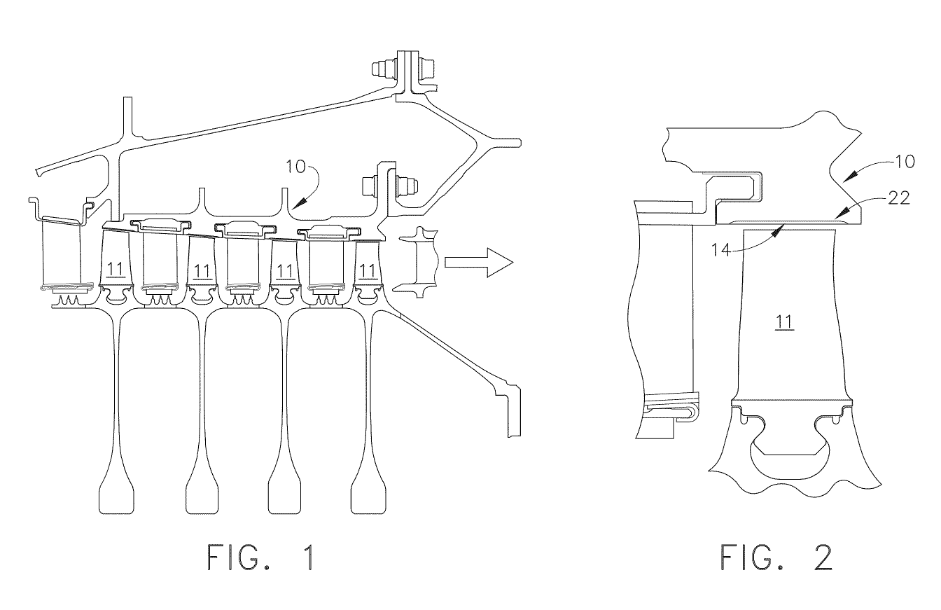

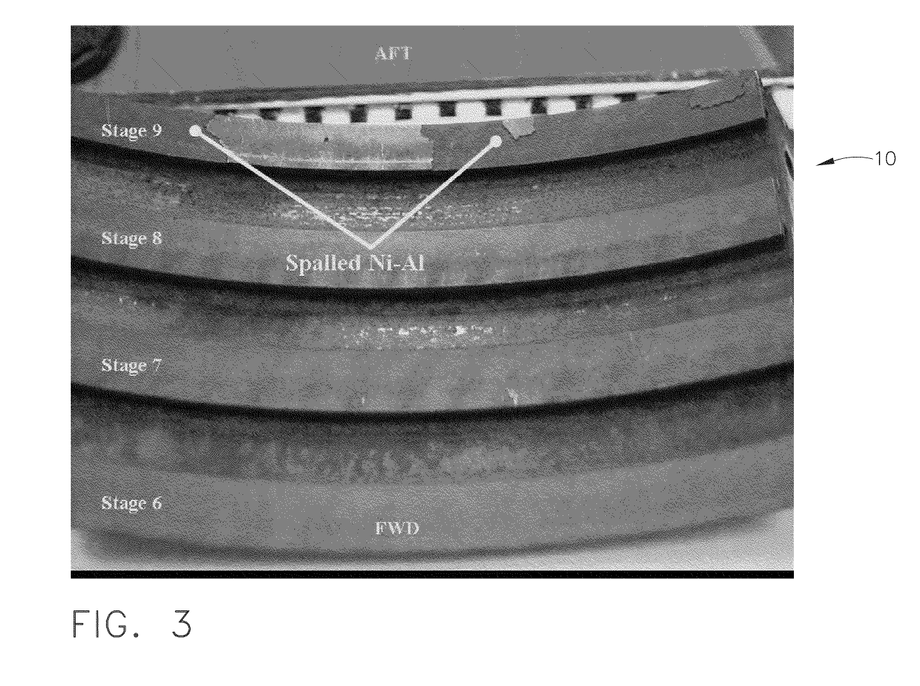

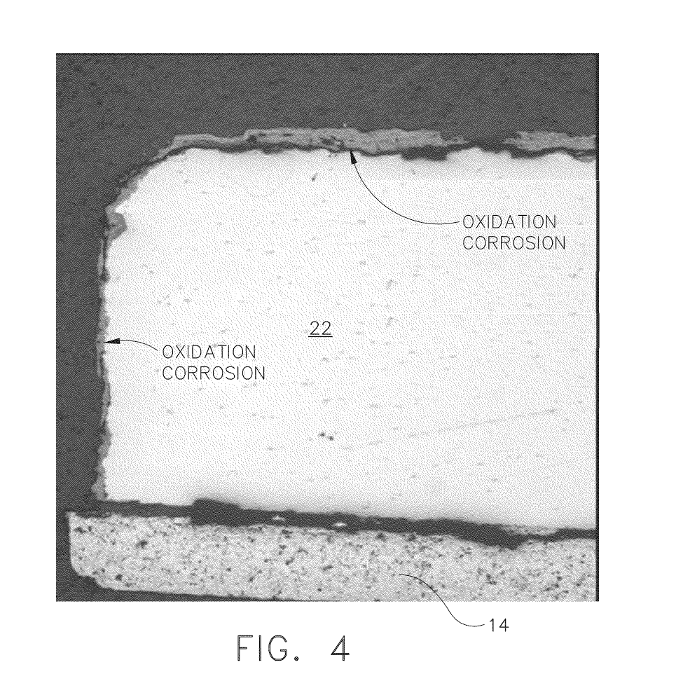

As previously described, compressor casings such as illustrated in FIGS. 1 and 2, as well as other flowpath parts are traditionally coated with corrosion-resistant environmental coatings. In the case of compressor casings, the coating is commonly made of an abradable material such as nickel-aluminum alloys, such as Ni—Al, and is known as a “rub coating” due to its abradable character. Such rub coatings are commonly applied by thermal spray. However, cycling of the turbine engine through normal operation eventually results in failure of such known rub coatings, such as by crack formation or “crazing” and spalling at the bond lines between the coating and the substrate, as exemplified by FIGS. 3-4. The failure of such coatings can cause significant damage to downstream components such as compressor blades and stator vanes, as well as to the substrate intended to be protected by the coating.

As previously described, MCrAlX coatings, such as Nickel-Chromium-Aluminum-Yttrium (NiCrAlY) coatings, are known for use as a bond coat to improve thermal carrier coating (TBC) adhesion on turbine components subjected to the most extreme engine temperatures. However, despite their desirable corrosion-resistant and crack-resistant characteristics, MCrAlX coatings have not been heretofore used as rub coatings on turbine engine components such as compressor casings. The present invention utilizes MCrAlX coatings as an abradable environmental rub coating for turbine engine flowpath parts, in lieu of Ni—Al, and other known abradable rub coatings more commonly used in similar high temperature and corrosive applications.

The inventors have found that MCrAlX, and particularly NiCrAlY, effectively addresses the two key drivers of rub coating failures as applied to compressor casings, for example. First, MCrAlX is less sensitive to engine thermal cycles and craze-cracking is reduced. Second, the coating bond line between an MCrAlX and the underlying alloy substrate is protected from oxidation/corrosion. With reduced cracking or bond failure, the NiCrAlY rub coating exhibits superior resistance to cracking, spalling, and other adhesion failures.

FIGS. 1 and 2 illustrate a compressor casing of a gas turbine engine assembly. While in service, a gas turbine engine component such as the compressor casing 10 is subjected to hot compressor gases, and is thereby subjected to severe thermal cycling, oxidation, corrosion and erosion. The coating serves as an abradable rub and wear surface to meet predetermined dimensions of the component, and to prevent direct wear of the underlying surface 22 of the component. Additionally, the rub coating is designed such that during a first engine run, the tips of the compressor blades 11 will penetrate into the rub coating and abrade a groove into the rub coating to generate a tight blade-to-flowpath clearance for subsequent operation, creating optimal engine efficiency. The rub coat can include at least one groove for accepting at least one compressor blade tip. For example, the resulting gap between the rub coating and the blade tip is expected to be about 0.001 inch, and less than about 0.010 inch. As previously described, known corrosion-resistant abradable rub coatings 14 applied to compressor casings and other flowpath components 10 suffer damage, such as thermally-induced cracking in combination to corrosion/oxidation of the interface, that eventually leads to coating failure. Loss of the coating 14 such as by spallation leads to premature damage to downstream components that may become damaged by liberated coating particles and other coating degradation by-products. In one embodiment, a surface of a substrate including a previously applied corrosion resistant rub coating may have been damaged or at least partially removed.

Represented in FIGS. 3-4 is a surface region of a component 10 previously protected by a prior art rub coat 14. The coating system is shown as being comprised of a rub coat 14 formed on the substrate surface 22 of the component 10. As is the situation with high temperature components of gas turbine engines, the component 10 may be formed of a nickel, cobalt or iron-base superalloy. The prior art rub coat 14 is preferably formed of an oxidation-resistant metallic material such as Ni—Al. The preexisting prior art rub coat 14 is non-compliant with predetermined dimensions and specifications due to prior use of the component in service, such as in an operating gas turbine aircraft engine. For example, as shown by the spalling of coating 14 identified in FIGS. 3-4, the rub coat 14 may be comprised of known 95%-5% Ni—Al that has cracked and/or spalled as a result of numerous thermal cycles experienced through operation of the engine.

In one embodiment, the invention comprises a new component, such as a compressor casing, for a gas turbine engine assembly. For example, a casing comprising a surface 22 coated with a corrosion resistant rub coating 14 comprising MCrAlX. Preferably, the MCrAlX comprises NiCrAlY.

In another embodiment, the invention comprises a repaired component 10 of a gas turbine engine assembly, the component 10 having a repair corrosion resistant rub coating 14 thereon, the repair corrosion resistant rub coating comprising MCrAlX. Preferably, the MCrAlX is NiCrAlY.

In another embodiment, the invention comprises methods of providing an abradable repair corrosion resistant rub coating to a previously coated component 10 of a gas turbine engine assembly. The method includes the steps of providing a component 10 of a gas turbine engine assembly, the component 10 having predetermined dimensions and specifications for operational use in an engine assembly. The component has a surface 22 having a preexisting coating thereon, the coating not in compliance with the predetermined dimensions and specifications. The method includes removing the non-compliant coating 14 to expose the surface 22. Removal can be by any known method, such as by mechanical, chemical, or water jet stripant to remove the old coating 14. Next, a repair corrosion resistant rub coating comprising MCrAlX is applied to the surface 22. Finally, the repair corrosion resistant rub coating 14 comprising MCrAlX is machined to restore the coated component 10 to comply with the predetermined dimensions and specifications.

In yet another embodiment, the invention comprises methods of repairing a previously in-service compressor casing. For example, the repair process begins with removal of any previously applied coating remaining on the surface 22 of the component 10. As previously described herein, removal can be by any known method, such as by mechanical, chemical, or water jet stripant to remove the old coating. The exposed surface 22 of the casing is then cleaned, if necessary, so as to remove loose oxides and any contaminants such as grease, oils and soot. Therefore, for a casing previously in service having a Ni—Al rub coating, the repair rub coating 14 adheres to the exposed surface 22. During application of the rub coating 14, the surface 22 is covered with a repair corrosion-resistant rub coating composition to form a rub coat 14. According to the invention, the rub coat 14 comprises a metallic MCrAlX alloy, preferably NiCrAlY. No post-deposition, pre-use, heat treatment is required to the applied rub coating 14, since upon deposition, such as by thermal spray, the repair rub coating 14 adheres to the surface 22 of the substrate component 10, as well as to any residual coating thereon, sufficiently to endure temperatures consistent with operational cycling of a gas turbine engine.

The invention provides an abradable corrosion resistant rub coating 14 comprising MCrAlX. The MCrAlX rub coating 14 is provided as an overlay coating, as opposed to known diffusion aluminide coatings such as NiAl. The MCrAlX rub coating 14 may be applied by any known means, but is preferably provided by thermal spray.

The chemical composition of the corrosion resistant rub coat 14 comprises an MCrAlX. More preferably the rub coat 14 comprises NiCrAlY. Preferably, the MCrAlX is a prelloyed powder that can be applied to the substrate surface 22 (such as a compressor casing) via conventional air plasma spray equipment and techniques to yield a relatively thick rub coating layer. By way of non-limiting example, in one example, the as-sprayed rub coating 14 is between about 0.001 inch to about 0.100 inch thick. In another example, the as-sprayed coating 14 is between about 0.015 to about 0.040 inch thick. In an exemplary rub coat 14 applied to a compressor casing, the as-sprayed rub coating 14 is between about 0.005 to about 0.015 inch thick. In another example the as-sprayed coating can be machined down to predetermined thickness. For example, the coating can be machined down to a desired thickness of between about 0.001 to about 0.080 inch thick. For example, the coating can be machined down to a desired thickness of between about 0.0035 to about 0.040 inch thick. However, the coating 14 can be applied in any thickness to meet the requirements of particular engine and compressor assemblies and applications. Because the MCrAlX rub coating 14 of the invention is readily machinable and abradable, it can therefore be machined down to a desirable and predetermined thickness that is appropriate for component installation. Additionally, due to the abradable nature of the coating 14, abrading of a groove may result upon initial turbine engine startup by penetration of the rotating compressor blade tips, which prevents damage to the compressor blade tips.

For example, it may be desirable not to apply the as-sprayed coating more than about 0.020 inch thicker than the desired post-machining thickness. Limiting the as-sprayed thickness in this manner may attenuate undesirable internal stresses created by the plasma spraying application of the coating and may help the coating to tolerate stresses of post-application machining and operation. In other applications, the rub coating may be sprayed over 0.020 inch thicker than the required post-machining thickness without reducing coating durability during machining or engine operation.

Examples of applied repair corrosion resistant rub coatings of the present invention are summarized in the following section.

### Prior Art Rub Coating

| Material Based on Weight | |
|---|---|
| Percentage | Weight % |
| Nickel | 95 |
| Aluminum | 5 |

An exemplary rub coating of the present invention comprises:

| Material Based on | |
|---|---|
| Weight Percentage | Weight % |
| Ni | (Balance) |
| Cr | 15-30 |
| Al | 5-15 |
| Y | 0.1-3.0 |

In another embodiment, the rub coating of the present invention comprises:

| Material Based on | |
|---|---|
| Weight Percentage | Weight % |
| Ni | (Balance) |
| Cr | 21-23 |
| Al | 9-11 |
| Y | 0.8-1.20 |
| Fe | <.20 |
| Si | <.10 |
| O | <.05 |
| Acid Insolubles | <.05 |
| Other impurities | <.20 |

The above examples are exemplary, and are not limiting. Other combinations and variations of ingredients and amounts are within the scope of the invention.

Testing of exemplary embodiments—Two virgin compressor case segments were each thermal sprayed via conventional air plasma spray, one with a prior art 95%-5% Ni—Al rub coating, and one with the NiCrAlY rub coating of the present invention as described in the above examples. Powder particle sizes for the present invention example ranged between −120 to +325 mesh (about −125 microns to about +45 microns). After coating by thermal spray to about 0.060 inch in thickness, the coatings were machined down to a predetermined thickness, in this particular example, to about 0.040 inch. These samples thus were designed at the upper extreme of applied and machined coating thicknesses, thereby maximizing stresses of coating application and machining.

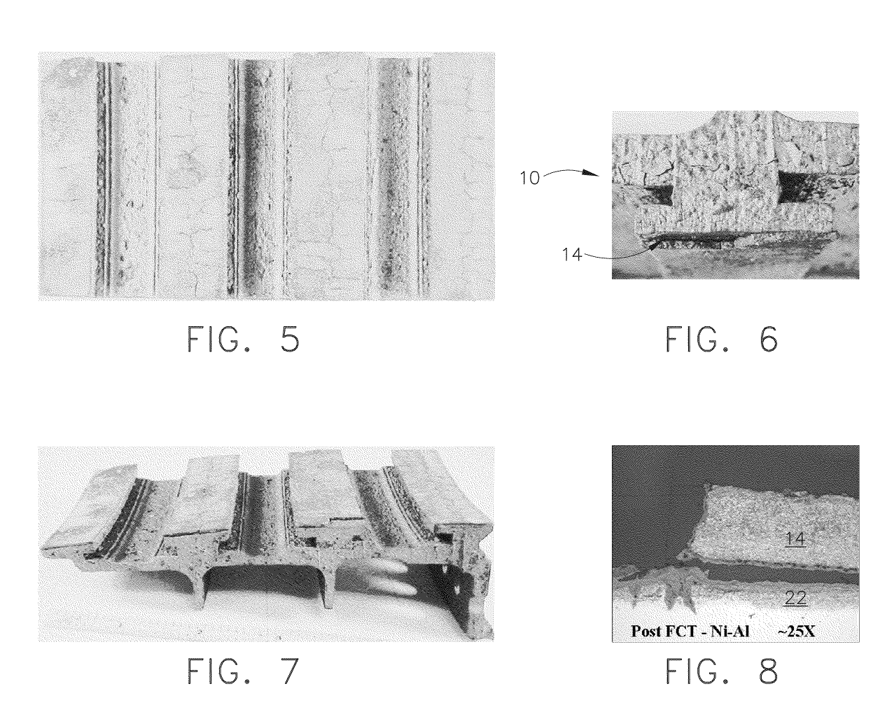

The resulting coated casings were subjected to furnace cycle testing (FCT) and blade wear testing to simulate conditions experienced during initial engine cut-in and subsequent engine operation over time. During FCT, the segments were thermally cycled from room temperature to 1400° F. and were also intermittently immersed in a salt-water bath to accelerate corrosion. Blade wear testing consisted of pushing a high-speed rotating disk of blades into the coating to determine both blade and coating rub and wear characteristics. The results of FCT and blade wear testing are illustrated in FIGS. 5-18.

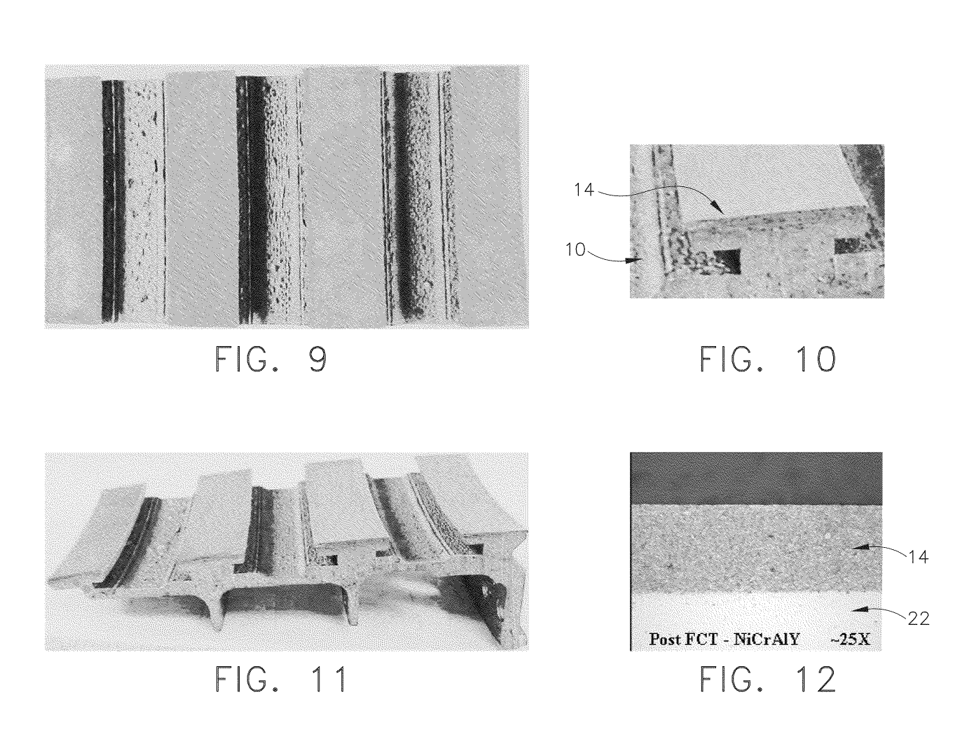

FIGS. 5-12 show the results of Furnace Cycle Testing of substrates coated with the prior art Ni—Al rub coating and the NiCrAlY rub coating of the second example, respectively. As seen in FIGS. 5-8, Ni—Al rub coated parts experienced cracking and spalling failures after 2856 cycles, such as those illustrated in FIGS. 2-3, and similar to failures seen in in-service engines. In stark comparison, as shown in FIGS. 9 through 12, parts coated with the NiCrAlY rub coating of the present invention and subjected to the same conditions did not suffer cracking or spalling after 2856 cycles.

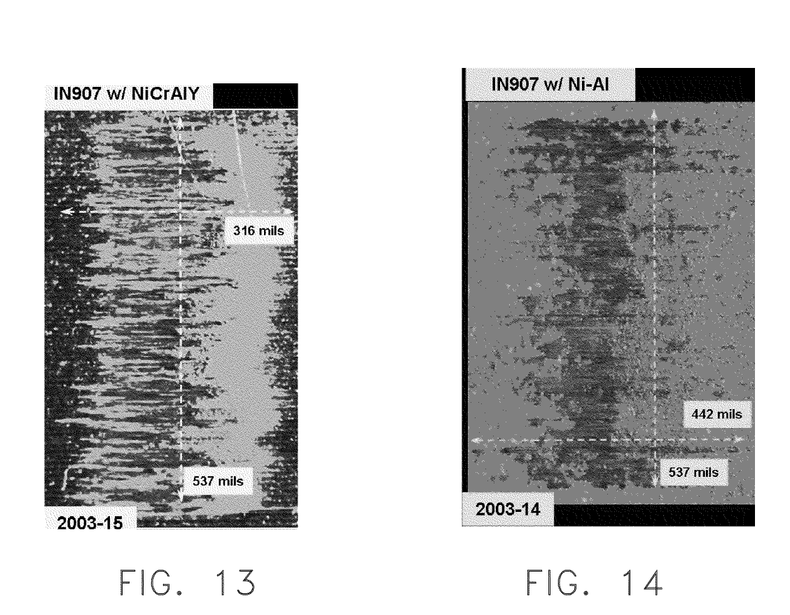

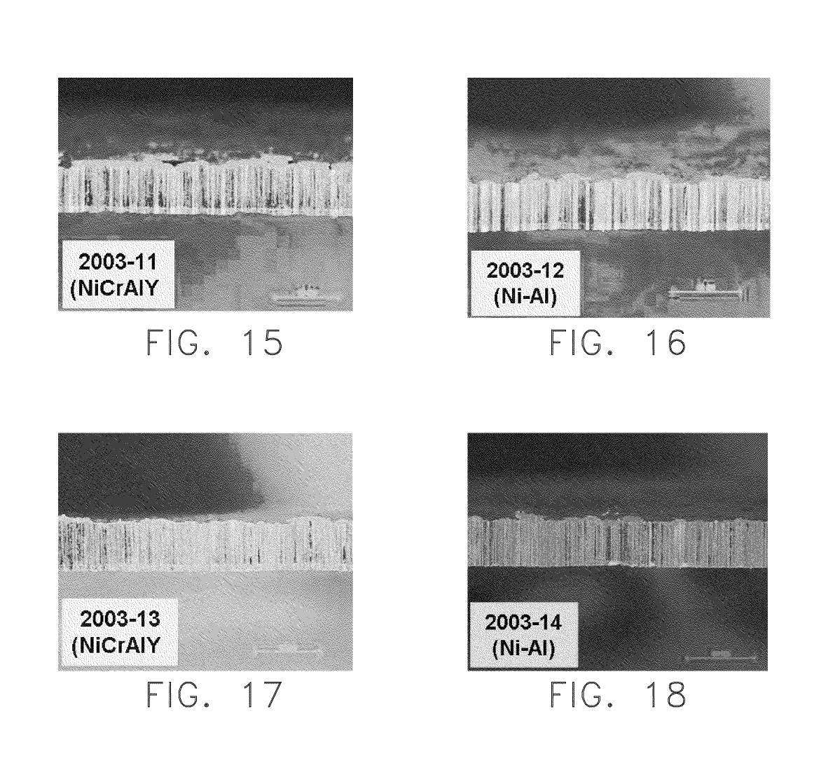

FIGS. 13-18 illustrate the results of wear testing. As shown in FIGS. 13 and 14, coating wear scars of the prior art Ni—Al rub coating on samples, and of the NiCrAlY rub coating applied samples were nearly identical, although NiCrAlY rub coating had a slightly smaller scar. With respect to blade tip wear, as shown in FIGS. 15 through 18, blade tip wear for both the Ni—Al rub coating and the NiCrAlY rub coating of the present invention was nearly identical. All tested blades showed uniform tip wear with no signs of tip cracking.

Available testing to date shows that flow path surfaces coated with NiCrAlY rub coatings are more durable than those having Ni—Al rub coatings, with less susceptibility to cracking, spalling, and corrosion at the bond line, and will therefore likely extend component service life beyond current capability of the prior art conventional Ni—Al rub coatings. As demonstrated in FIGS. 5-18, testing of applied repair coatings 14 comprising NiCrAlY showed superior performance over Ni—Al rub coatings, both in terms of adhesion, resistance to cracking, and prevention of corrosion at the bond line between coating layers and between the coating and the substrate. While coating composition and application methods are currently being optimized for particular substrates, rub coatings comprising essentially NiCrAlY are expected to yield similar results and advantages over other known rub coatings such as Ni—Al coatings, even when applied by conventional methods known to those skilled in the art.

While the invention has been described with reference to a preferred embodiment, it will be understood by those skilled in the art that various changes may be made and equivalents may be substituted for elements thereof, without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for providing a repair corrosion resistant rub coating on a component surface, the method comprising the steps of:
providing a previously coated component of a gas turbine engine assembly, the component having predetermined dimensions and specifications for operational use in the gas turbine engine assembly, the component having a surface having a rub coating thereon, the rub coating not in compliance with the predetermined dimensions and specifications;
removing the non-compliant rub coating to expose the surface;
providing a corrosion resistant rub coating composition comprising MCrAlX;
applying the corrosion resistant rub coating composition to the surface to yield a repair corrosion resistant rub coat;
machining the repair corrosion resistant rub coat to restore the coated component to comply with the predetermined dimensions and specifications.

2. The method of claim 1, wherein the non-compliant rub coating comprises a Nickel-Aluminum (Ni—Al) alloy.

3. The method of claim 1, wherein the corrosion resistant rub coating composition comprises NiCrAlY.

4. The method of claim 1, wherein the corrosion resistant rub coating composition consists of NiCrAlY.

5. The method of claim 1, wherein the component is a compressor casing.

6. The method of claim 3, wherein the NiCrAlY corrosion resistant rub coating composition comprises:
approximately 15-30 weight percent Chromium (Cr);
approximately 5-15 weight percent Aluminum (Al);
approximately 0.1-3.0 weight percent Yttrium (Y); and
the balance Nickel (Ni).

7. The method of claim 4, wherein the NiCrAlY corrosion resistant rub coating composition consists of:
approximately 15-30 weight percent Chromium (Cr);
approximately 5-15 weight percent Aluminum (Al);
approximately 0.1-3.0 weight percent Yttrium (Y); and
the balance Nickel (Ni).

8. The method of claim 1, wherein the corrosion resistant rub coating composition consists of MCrAlYR.

9. The method of claim 8, wherein M is Nickel (Ni) and R is selected from the group consisting essentially of: Iron (Fe), Silicon (Si), and Oxygen (O), and combinations thereof.

10. The method of claim 9, wherein the NiCrAlR coating composition comprises:
approximately 21-23 weight percent Chromium (Cr);
approximately 9-11 weight percent Aluminum (Al);
approximately 0.8-1.2 weight percent Yttrium (Y);
approximately less than 0.20 weight percent Iron (Fe);
approximately less than 0.10 weight percent Silicon (Si)
approximately less than 0.05 weight percent Oxygen (O); and
the balance Nickel (Ni).

11. The method of claim 1, wherein the repair corrosion resistant rub coat includes at least one groove for accepting at least one compressor blade tip.

12. The method of claim 1, including an additional step after the step of removing and prior to the step of applying the corrosion resistant rub coating composition of cleaning the exposed surface.

13. The method of claim 1, wherein the repair corrosion resistant rub coat as applied has a thickness of approximately 0.001 inches to approximately 0.100 inches.

14. The method of claim 1, wherein the repair corrosion resistant rub coat as applied and after machining has a thickness of approximately 0.001 to approximately 0.080 inches.

15. The method of claim 1, wherein a resulting gap between the repair corrosion resistant rub coat and a blade is less than about 0.010 inch.

16. The method of claim 1, wherein a resulting gap between the repair corrosion resistant rub coat and a blade is about 0.001 inch.

17. The method of claim 1, wherein the repair corrosion resistant rub coat adheres to the surface without heat treatment.

18. The method of claim 1, wherein the repair corrosion resistant rub coat is resistant to operation cycling of a gas turbine assembly.
